(19) United States
(12) Patent Application Publication
(10) Pub. No.: US 2013/0329721 A1
(43) Pub. Date: Dec. 12, 2013

(54) APPARATUS, METHOD AND COMPUTER PROGRAM FOR DETERMINING A FREQUENCY OFFSET

(71) Applicants: Uwe Doetsch, Freudental (DE); Michael Ohm, Stuttgart (DE)

(72) Inventors: Uwe Doetsch, Freudental (DE); Michael Ohm, Stuttgart (DE)

(73) Assignee: ALCATEL LUCENT, Paris (FR)

(21) Appl. No.: 14/000,021

(22) PCT Filed: Dec. 16, 2011
(86) PCT No.: PCT/EP11/73054

§ 371 Date: Aug. 16, 2013

(30) Foreign Application Priority Data
Feb. 18, 2011 (EP) 11290095.4

(51) Int. Cl. H04W 56/00

(52) U.S. Cl. CPC H04W 56/0035
USPC 370/350

(57) ABSTRACT

Embodiments relate to a concept for determining an estimate (17) of a frequency offset between a carrier frequency of a received signal (12) and a carrier frequency of a transmitted signal, comprising determining, based on the received signal (12), an estimate (13) of the carrier frequency of the received signal (12), generating a reference signal (15) having a reference frequency corresponding, within a predefined tolerance range, to the carrier frequency of the transmitted signal, and estimating the frequency offset (17) based on the estimated carrier frequency (13) of the received signal (12) and the reference frequency of the reference signal (15).

Embodiments of the present invention relate to mobile communication systems, and, in particular, to an estimation of a frequency offset so-called direct air-to-ground (DA2G) communication systems.

### BACKGROUND

Airlines are currently investigating solutions to provide broadband connectivity for their passengers. Candidates for instance commercial systems a Long-Term Evolution (LTE), which has been standardized as the successor of the Universal Mobile Telecommunications System (UMTS). For the downlink transmission, i.e. the direction from a base station (BS, NodeB or eNodeB) to a mobile terminal or UE (User Equipment), LTE utilizes Orthogonal Frequency Division Multiple Access (OFDMA) as the physical layer technique which enables high data rate transmission, particularly in frequency selective fading scenarios. LTE as the technology basis for a terrestrial cellular direct air-to-ground (DA2G) communication system is a favorable option for the airlines' continental fleets compared to satellite solutions due to the provision of higher bandwidth at lower cost.

The LTE air interface is optimized for terrestrial cellular networks. In the terrestrial environment there is a lot of fading in a mobile communications channel and propagation loss is often much heavier then free space loss due to the presence of buildings and other obstacles. In the direct air-to-ground scenario, wherein a terrestrial mobile communications network is used for a communication between a mobile terminal located in an aircraft and a ground-located base station, some partial fading may still occur but it Will be typically much less severe than the fading that a terrestrial UE on the ground may encounter. Instead, the DA2G scenario s characterized by a wireless communications channel with a dominating line-of-sight (LOS) component. Reflected paths are either negligible or—if observable—at up to 20 dB in power below the direct (LOS) path—with almost the same Doppler shift as the LOS-component. Due to the dominating LOS-component the DA2G scenario is a Doppler shift scenario rather than a Doppler spread scenario as in terrestrial ground-to-ground systems. The Doppler shifts observed in the DA2G scenario relate aircraft speeds up to 1200 km/h. For example, assuming a center or carrier frequency f_{C}=2 GHz and a velocity v=1200 km/h, a maximum Doppler shift f_{Doppler,max}=(v/c)·f_{C}=2.2 kHz may be observed, wherein c denotes the speed of light.

One of the drawbacks of Orthogonal Frequency Division Multiplexing (OFDM) is its vulnerability to carrier frequency offset. LTE employs a fixed subcarrier spacing of 15 kHz. Hence, hen left uncompensated, a carrier frequency shift of e.g. 2.2 kHz due to the Doppler effect may already lead to non-negligible inter-carrier interference destroying the orthogonality between adjacent subcarriers. LTE, however, has been designed for terrestrial use and the use of pilot-aided channel estimation methods in LTE is not sufficient in high-speed direct air-to-ground propagation scenarios. The resulting high Doppler shifts cannot unambiguously be estimated from available pilot signals and thus a proper Doppler compensation on the received and/or transmitted signals is not possible.

In the downlink from a base station to a terminal (i.e. from the base station to an aircraft onboard unit, OBU, in the DA2G scenario) the discrete Doppler shift appears to the mobile terminal receiver or the aircraft onboard unit just as an offset from the base station carrier frequency f_{C,tx} of the transmitted downlink signal. The mobile terminal receiver derives the carrier frequency of the transmitted downlink signal from the received downlink signal by state-of-the-art frequency estimation methods, and cannot distinguish between a frequency offset at the base station transmitter or a frequency shift caused by the Doppler effect. The terminal receiver just adapts to the shifted frequency without any performance impact (within the range of Doppler shifts observed in the DA2G scenario).

For an uplink transmission from the mobile terminal to the base station (i.e. from the aircraft onboard unit to the base station in the DA2G scenario), a mobile terminal transmitter uses a carrier frequency derived from the Doppler shifted base station carrier frequency f_{C,tx}+f_{o,Doppler}. For an LTE FDD (Frequency Division Duplex) system this mobile terminal uplink carrier frequency is the Doppler shifted base station carrier frequency (f_{C,tx}+f_{o,Doppler}) plus a duplex offset Δf_{FDD}. For LTE TDD (Time Division Duplex) it is the Doppler shifted base station carrier frequency (f_{C,tx}+f_{o,Doppler}). As the uplink signal from the mobile terminal transmitter in the aircraft onboard unit also experiences the Doppler shift f_{o,Doppler}, has a frequency offset of twice the Doppler shift when it reaches the base station.

This frequency offset of twice the Doppler shift can be beyond the estimation capabilities of the base station in the direct air-to-ground scenario. At the same time the base station needs to receive uplink signals from multiple mobile terminals or aircraft onboard units that may have frequency differences of four times the maximum Doppler shift. Four times because one mobile terminal (aircraft) may move away from the base station and another mobile terminal (aircraft) may move towards the base station at maximum allowed speed.

It is thus desirable to perform a Doppler pre-compensation by twice the Doppler shift at the mobile terminals or the aircraft onboard units.

It is known to estimate the Doppler shift a direct air-to-ground scenario by geometrical calculations based on e knowledge of the ground-located base station positions, which may be stored in a database in the onboard terminal, and the heading and speed of the aircraft obtained from an aircraft navigational system or a GPS (Global Positioning System) receiver built into the onboard terminal. For that reason a mobility client entity may receive GPS information and base station position information and calculate the Doppler shift, which can then be compensated in a specific DA2G processing entity.

This solution has two drawbacks. Firstly, the system relies on GPS or other navigational data. This adds complexity as additional interfaces or components are required. Both the required access to the aircraft data bus carrying navigational data or the required additional GPS antenna limit installation positions inside the aircraft. If the GPS signal or navigational data are corrupted the system cannot be operated. Secondly, an up-to-date database of base stations and their positions is required. If new base stations are added to the communications system or single base station failures appear, the database becomes inaccurate and the system cannot be operated properly at least in parts of the system's coverage area.

Hence, it is desirable to provide improved estimation concepts for estimating speeds or Doppler frequencies in a mobile communications network, in particular in a direct air-to-ground scenario.

### SUMMARY

An embodiment provides an apparatus for determining an estimate of a frequency offset between a carrier frequency of received signal and a carrier frequency of a transmitted signal. The apparatus comprises a processor for determining, based on the received signal, an estimate of the carrier frequency of the received signal. A reference signal source is provided for generating a reference signal having a reference frequency corresponding, within a predefined tolerance range, to the carrier frequency of the transmitted signal. An estimator may estimate the frequency offset based on the estimated carrier frequency of the received signal and based on the reference frequency of the reference signal.

In a direct air-to-ground communication scenario, wherein a terrestrial mobile communications network is used for a communication between a mobile terminal located in an aircraft and a ground-located base station, the frequency offset may be a Doppler frequency offset resulting from a movement of the aircraft relative to ground. In such a scenario the received signal is a version of the transmitted signal compromised or corrupted by a wireless communications channel between a receiver of the received signal, e.g. a mobile aircraft onboard terminal, and a transmitter of the transmitted signal, e.g. a terrestrial base station. The transmitted as well as the received signal may both be downlink signals, wherein the transmitted downlink signal is sent towards the aircraft from a ground-located base station of a terrestrial mobile communications system.

The transmitted and, hence, the received signal may be, depending on the used terrestrial communications system, a code division multiplexing signal (CDMA) or an orthogonal frequency division multiplexing signal (OFDM). CDMA signals are, e.g., used in 3^{rd} generation mobile communications systems, like the UMTS system. As has been explained before, the downlink of the LTE system is based on OFDM/OFDMA. It is emphasized that embodiments are not limited to CDMA or OFDM signals. Embodiments may also be employed for other multiple access techniques like TDMA (Time Division Multiple Access) or FDMA (Frequency Division Multiple Access), or combinations thereof, like they are, e.g., used in GSM/EDGE communication systems.

According to embodiments the processor may be adapted to determine the estimate of the frequency offset of the received signal carrier frequency based on a center frequency of the received signal or its frequency spectrum. This is the frequency with which a time-domain signal is transmitted from a transmitter antenna device to a receiver antenna device.

Embodiments may employ a highly accurate reference clock in a mobile terminal receiver. This reference clock may run independently from other clocks used in RF (Radio Frequency) and digital processing terminal receiver parts for the received signal at the known carrier frequency of the transmitter. According to embodiments, the transmitter may be a base station of mobile communications system. The frequency offset, which may be caused by the Doppler effect, may be estimated to be a frequency difference between the highly accurate reference clock and the center or carrier frequency of the received signal, as the latter is the carrier frequency at the transmitter plus the experienced Doppler shift.

In embodiments the apparatus for determining the frequency offset estimate may be located in an onboard terminal of an aircraft. Hence, embodiments also comprise an aircraft comprising an apparatus for determining an estimate of a frequency offset. In this case, power consumption, battery life and/or costs are issues that may be less critical compared to typical consumer mobile terminals, like e. g. cell phones. Hence, it is possible to employ more accurate and/or stable reference clocks in such an aircraft onboard terminal. In some embodiments the reference signal source may be as accurate as reference clocks typically used in base stations, which means that the reference signal source may have an accuracy of ±0.05 ppm (parts per million), wherein one part per million denotes one part per 1,000,000 parts, one part in 10⁶, and a value of 1×10⁻⁶. For an exemplary nominal reference frequency f_{C}=2 GHz an accuracy of ±0.05 ppm means that an actual frequency generated by the reference clocks does not deviate from the nominal reference frequency by more than ±100 Hz.

In one embodiment the reference signal source comprises a highly accurate reference clock running at the same frequency as the transmitter, which may be a base station transmitter. The estimator may comprise a frequency comparator to estimate the frequency offset or the Doppler shift by a comparison of the highly accurate reference clock signal to a signal of a local oscillator which is tuned to the center frequency of the received signal or frequency spectrum. In other words the reference signal source may comprise a tunable local oscillator and the processor may be adapted to synchronize, based on the received signal, a frequency of the tunable local oscillator to the carrier frequency of the received signal to obtain a synchronized frequency of the tunable local oscillator as the estimate of the carrier frequency of the received signal. The estimator may be adapted to estimate the frequency offset based on a difference between the synchronized frequency of the tunable local oscillator and the reference frequency of the highly accurate reference signal. For that purpose the estimator may comprise a frequency comparator to determine the frequency difference between the synchronized frequency and the reference frequency.

According to a further embodiment the processor may be adapted to determine the estimate of the carrier frequency of the received signal based on the reference signal and a down-converted signal, which is obtained by mixing the reference signal with the received signal. In this embodiment the frequency offset, which may result from a Doppler shift plus any additional offset coming e.g. from an inaccuracy of the reference signal source, is not compensated by tuning a local oscillator. Instead, the frequency offset may be fully compensated in the digital domain by appropriate signal processing algorithms. The output from the carrier frequency estimator may be directly compared to the frequency of the reference signal source to obtain the estimate of the frequency offset, i.e. the Doppler shift plus any other inaccuracy-offset. Preferably an accuracy of the reference signal source, e.g. a fixed local oscillator, is high enough, such that there is negligible frequency offset resulting from its own inaccuracy. I.e., also in this embodiment the reference signal source may be adapted to generate the reference signal set such that its reference frequency corresponds to the carrier frequency of the transmitted signal within the range of ±0.05 ppm.

Note that in embodiments the accuracy that needs to be achieved by the independently running highly accurate reference signal source in the mobile terminal should be in a dimension such that unwanted frequency offsets due to its inaccuracy are tolerable within defined performance bounds in the processing chain of the mobile terminal's downlink receiver, its uplink transmitter and the base station's uplink receiver. Furthermore, the accuracy of the local oscillator at the transmitter (base station) used to generate the downlink signal is assumed to be high enough such that any frequency offsets are negligible.

According to some embodiments, the apparatus further comprises a transmitter for transmitting a radio signal via a reverse communication link (e.g. uplink) to an origin of the transmitted signal, e.g. a ground-located base station. A frequency offset compensator may be foreseen to configure a carrier frequency of the radio signal based on the estimated frequency offset. I.e., before transmitting the radio signal in the reverse communication link, e.g. the uplink from the aircraft's on-board terminal to the base station, the carrier frequency of the uplink signal may be adjusted based on the estimated (Doppler) frequency offset. The compensated uplink carrier frequency f_{C,uplink,comp} may then deviate from a nominal uplink carrier frequency f_{C,uplink,nom} by the negative frequency offset estimate, i.e. f_{C,uplink,comp}=f_{C,uplink,nom}−f_{Doppler,est}. In this case the uplink signal transmitted from the moving aircraft reaches the base station at approximately the nominal uplink carrier frequency f_{C,uplink,nom}.

Embodiments may further comprise a method for determining an estimate of a frequency offset between a carrier frequency of a received signal and a carrier frequency of a transmitted signal. The method comprises steps of determining, based on the received signal, an estimate of the carrier frequency of the received signal, generating a reference signal having a reference frequency corresponding, within a predefined tolerance range, to the carrier frequency of the transmitted signal, and estimating the frequency offset based on the estimated carrier frequency of the received signal and the reference frequency of the received signal.

Moreover, embodiments may comprise a computer program having a program code for performing one of the above methods when the computer program is executed on a computer or processor.

Here and in the remainder, information can typically be exchanged using signaling. Exchanging a signal may comprise writing to and/or reading from a memory, transmitting the signal electronically, optically, or by any other appropriate means.

Embodiments may allow for an efficient and robust implementation of Doppler estimation required for Doppler pre-compensation for uplink transmission in an aircraft's LTE onboard unit. Embodiments may lead to self-containment of an LTE DA2G onboard unit with respect to the Doppler compensation, i.e., no interfaces are required to additional systems like GPS or other navigational information systems. This may reduce the probability for failures and may ease installation processes inside the aircraft. Furthermore, no up-to-date base station database may need to be maintained with the LTE DA2G on-board unit.

### BRIEF DESCRIPTION OF THE FIGURES

Some embodiments of apparatuses and/or methods will be described in the following by way of example only, and with reference to the accompanying figures, in which

FIG. 1 shows a schematic block diagram of an apparatus for determining an estimate of a frequency offset according to an embodiment;

FIG. 2 shows a more detailed block diagram of apparatus for determining an estimate of a frequency offset according to a further embodiment;

FIG. 3 shows a block diagram of an apparatus for determining a frequency-offset-estimate according to yet a further embodiment; and

FIG. 4 shows a schematic flowchart illustrating a method for determining a frequency-offset-estimate according to an embodiment.

### DESCRIPTION OF EMBODIMENTS

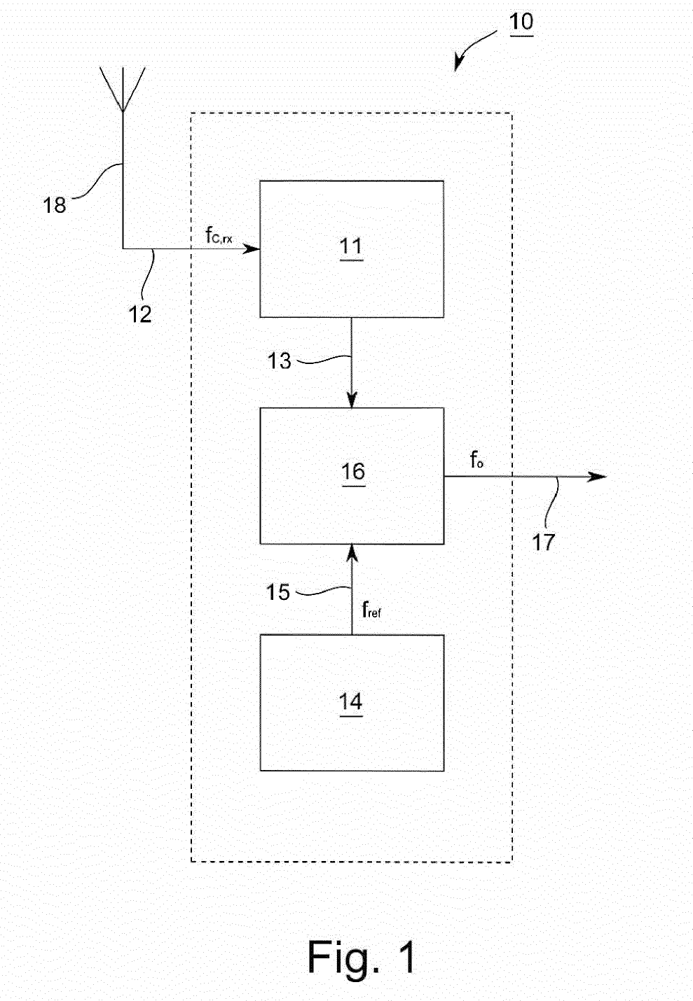

FIG. 1 shows a schematic block diagram of an apparatus 10 for determining an estimate 17 of a frequency offset fₒ between a carrier frequency f_{C,rx} of a received signal 12 and a carrier frequency f_{C,tx} of a transmitted signal.

The apparatus 10 comprises a processor 11 for determining, based on the received signal 12, an estimate 13 of the carrier frequency f_{C,tx} of the received signal 12. The apparatus 10 further comprises a reference signal source 14 for generating a reference signal 15 having a reference frequency f_{ref} corresponding, within predefined tolerance range Δf_{ref}, to the carrier frequency f_{C,tx} of the transmitted signal. The frequency offset 17 may be estimated by an estimator 16 based on the estimate 13 of the carrier frequency f_{C,rx} of the received signal 12 and the reference frequency f_{ref} of the reference signal 15.

For example, the apparatus 10 may be coupled with or built into a mobile onboard terminal of an aircraft for a direct air-to-ground communication (DA2G) between the aircraft and at least one base station of a terrestrial mobile communications network. In such an embodiment, the apparatus 10 may be employed in order to determine an estimate of a Doppler shift f_{o,Doppler} as the frequency offset fₒ. The movement of the aircraft introduces a Doppler frequency shift. Since the direct air-to-ground communication between the aircraft and a base station is characterized by a dominant line-of-sight channel component between the moving aircraft and the terrestrial base station one may assume a rather discrete Doppler shift instead of a Doppler spectrum, which is more common for non-line-of-sight mobile fading channels.

The received signal 12 may e.g. be interpreted as a downlink signal stemming from the terrestrial base station and transmitted towards the moving aircraft. For its reception the apparatus 10 may be coupled to an antenna or an antenna array 18. In a line-of-sight (LOS) scenario, like the DA2G scenario, an antenna array can be particularly advantageous since receive- as well as transmit-beamforming algorithms may be effectively employed in such OS-scenarios.

The usage of embodiments of the apparatus 10 is generally not limited to a processing of OFDM signals. However, the received signal 12 as well as the transmitted signal may be regarded as such OFDM signals, which are used in the downlink of 4^{th} generation mobile communication systems such LTE. Since LTE is capable of delivering broadband services also to aircraft passengers some embodiments of the present invention are directed towards LTE-OFDM/OFDMA. As has been explained before, an uncompensated frequency offset fₒ is particularly critical for OFDM based signals, since this modulation technique relies on mutually orthogonal sub-carriers. For that reason, and in order to avoid severe performance degradations, a frequency offset compensation should be performed before converting a received time-domain OFDM signal into the frequency domain for further processing. In the direct air-to-ground scenario scenario the frequency offset compensation may be performed by adjusting an uplink carrier frequency based on the estimated Doppler shift of the received downlink signal, since a frequency offset of twice the Doppler shift may be beyond the estimation capabilities of the base station in the DA2G scenario, as has been explained before.

According to embodiments the carrier frequency f_{C,rx} of the received signal (as well as the transmitted signal) may be understood as the center frequency of a used communication band. Hence, the center frequency of the wireless transmitted and/or received signal will depend on an available spectrum, which may differ between different operators and/or different countries. The processor 11, hence, may be adapted to determine the estimate 17 of the carrier frequency f_{C,rx} of the received signal 12 based on the center frequency of a received signal frequency spectrum. The bandwidth of received signal frequency spectrum is dependent on a mode of operation of the wireless communications system. For example, if UMTS/WCDMA was used as the underlying communications system, the received (transmitted) signal bandwidth would be 5 MHz. In LTE-systems a scalable signal bandwidth may vary between 5 MHz, 10 MHz, 15 MHz and 20 MHz.

Embodiments rely on a highly accurate reference signal source 14 in the mobile terminal operating at the known carrier frequency f_{C,tx} of the base station transmitter. Thereby the reference signal source 14 operates independently from other signal sources used in RF and digital signal processing terminal receiver parts for the received signal 12. The carrier frequencies f_{C,tx} of the base stations may, e.g., be stored in a dedicated digital storage or database comprised by the apparatus 10. Typically, LTE uses a frequency reuse factor of one, which means that adjacent or neighboring cells or base stations will use the same frequency band and, hence, the same transmit carrier or center frequency f_{C,tx}. However, the used carrier frequencies of the base stations may vary for different operators of wireless communications systems, depending on available spectral resources. Hence, the storage in the apparatus 10 may provide different transmit signal carrier frequencies for different network providers.

The frequency offset fₒ caused by the Doppler effect can be estimated by the estimator 16 to be the frequency difference between the highly accurate reference signal 15 having the reference frequency f_{ref} and the estimate 13 of carrier frequency f_{C,rx} of the received downlink signal 12, as the latter corresponds to the carrier frequency f_{C,tx} at least base station transmitter plus the experienced Doppler shift f_{o,Doppler}.

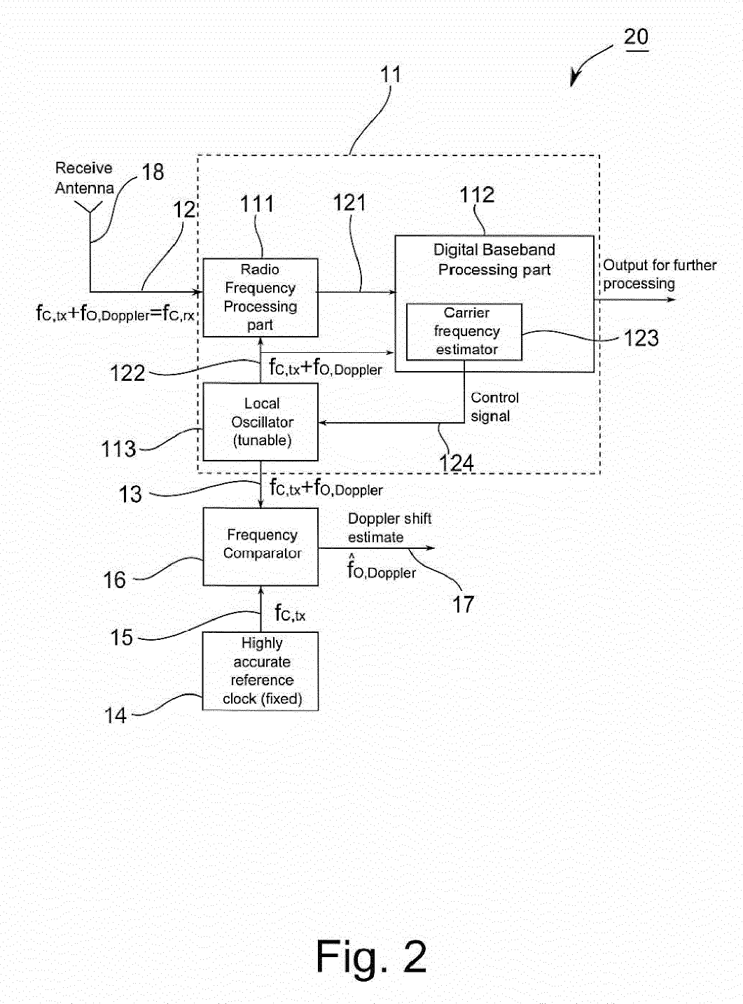

Turning now to FIG. 2, a further embodiment of an apparatus 20 for determining a frequency-offset-estimate will be described. The same reference numerals as in FIG. 1 indicate similar functional components and/or signals.

Here the processor 11 comprises (Radio Frequency) processing part 111, a digital baseband processing part 112 and a tunable local oscillator 113. The radio frequency processing part 111 may be coupled to the receive antenna device 18 such that the received signal 12 is input from the receive antenna device 18 to the RF-processing part 111, which may be an analog RF front-end receiver. Hence, the RF-processing part 111 may comprise electrical circuitry to down-convert the received analog signal 12 from the analog RF-signal domain to an intermediate frequency domain or to an analog or digital baseband domain. A down-converted baseband signal 121 is fed from the RF-processing block 111 to the digital baseband processing block 112. The down-conversion of the received signal 12, having the center or carrier frequency f_{C,rx} corresponding to f_{C,tx}+f_{o,Doppler}, into the intermediate frequency or baseband domain may be achieved by mixing the received signal 12 with an output signal 122 of the tunable local oscillator 113. In embodiments the tunable local oscillator 113 may be used for a direct down-conversion of the received signal 12 to the baseband domain.

The RF-front-end 111, the digital baseband processor 112 including a carrier frequency estimator 123, and the tunable local oscillator 113 together form a control loop for synchronizing the frequency of the local oscillator's output signal 122 to the center frequency f_{C,rx} of the received signal 12. For this reason the LO-signal 122 or frequency information thereof may be provided to the carrier frequency estimator 123, which may be implemented in the baseband processing part 112 in some embodiments. The local oscillator's 113 output signal or the frequency information thereof may be used in the baseband processor 112 and/or the carrier frequency estimator 123 for clearing out ambiguous Doppler frequency offset estimates. In other embodiments the carrier frequency estimator 123 may also be realized by analog or digital circuitry comprised by the RF-front-end 111.

According to some embodiments the carrier frequency estimator 123 may perform a cell search procedure in order to derive a first estimator for the carrier frequency f_{C,rx} of the received signal 12. In LTE the cell search procedure is based on the use of primary and secondary synchronization signals. For the cell search the carrier frequency estimator 123 may be adapted to search for the primary synchronization signal at the center frequencies f_{C,tx} possible at the frequency band in question. For this purpose a control signal 124 may be used for controlling the tunable local oscillator 113 to the possible center frequencies f_{C,tx}. There exist three different possibilities for the primary synchronization signal as the primary synchronization signal may point to one of three Physical-layer Cell Identities (PCI). Once the primary synchronization signal has been detected, the mobile terminal may look for the secondary synchronization signal pointing at one of 168 PCI groups.

Once one alternative for 168 possible secondary synchronization signals as been detected, the UE has figured out the PCI value from an address space of 504 IDs. From the PCI the UE may derive information about the parameters used for downlink reference signals and thus the UE may decode the PBCH (physical broadcast channel) carrying system information needed to access the mobile communications system.

After initial carrier frequency estimation the carrier frequency estimator 123 may be adapted, in one embodiment, to output a non-vanishing control signal 124 in response to a detected a non-vanishing residual frequency offset in the down-converted digital baseband signal 121. In order to avoid ambiguities when estimating the residual frequency offset, frequency information of the LO-signal 122 may be used in the baseband part 112, 123. Thereby the residual frequency offset may e.g. be obtained by covariance methods, level-crossing rate methods or power-spectrum measurements. Based on the residual frequency offset the control signal 124 may be used for controlling or tuning the local oscillator 113 to the shifted center frequency f_{C,rx} of the received signal 12. In other words the processor 11 is adapted to synchronize, based on the received signal 12, the frequency of the tunable local oscillator 113 to the carrier frequency f_{C,rx} of the received signal 12 to obtain a synchronized frequency of the tunable local oscillator 113, which may then also be used as the estimate 17 of the received carrier frequency. As shown in FIG. 2 the synchronization may be achieved with a control loop similar to a phase-locked-loop (PLL), wherein the control loop comprises the RF front-end 111, the digital baseband processor 112 and the tunable local oscillator 113.

In the embodiment depicted in FIG. 2 the carrier frequency estimator 123 resides in the digital baseband part 112 of the processor 11. The carrier frequency estimator 123 may, however, also be implemented by analog circuits residing in the radio frequency processing circuit 111. The carrier frequency estimator 123 is adapted to control the local oscillator 113 of the processor 11 in such a way that its output frequency coincides with the center or carrier frequency f_{C,rx} of the frequency-shifted received signal 12. The center frequency f_{C,rx} of the received signal 12 is the base station transmitter's carrier frequency f_{C,rx} plus the frequency offset f_{o,Doppler} caused by the Doppler effect.

According to the embodiment of FIG. 2, the output signal 122 of the local oscillator 113 is fed, as the estimate 13 of the carrier frequency of the received signal, to the estimator 16 for estimating the frequency offset fₒ=f_{o,Doppler} based on the estimate 13 of the carrier frequency f_{C,rx} and based on the reference frequency f_{ref} of the reference signal 15 coming from the highly accurate reference signal source 14. The estimator 16 may be adapted to determine the estimate 17 for the frequency offset f_{o,Doppler} based on a difference between the synchronized frequency f_{LO}=(f_{C,tx}+f_{o,Doppler}) of the local oscillator 113 (or its output signal 122) and the reference frequency f_{ref}=f_{C,tx} of the reference signal 15. For this reason, embodiments of the estimator 16 may comprise a frequency comparator to determine the difference between the synchronized LO-frequency f_{LO}=(f_{C,tx}+f_{o,Doppler}) and the reference frequency f_{ref}=f_{C,tx}. In other words, in the frequency comparator 16 the variable frequency f_{LO} of the local oscillator's 113 output signal 122 is compared to the stable frequency f_{ref} of the highly accurate reference signal source or reference clock 14 in order to derive the frequency-offset-estimate 17. The frequency comparator 16 may be implemented using digital or analog circuits or combinations thereof.

According to embodiments the reference signal source 14 is adapted to generate the (independent) reference signal 15 such that its reference frequency f_{ref} corresponds to the carrier frequency f_{C,tx} of the transmitted signal within the range of ±0.1 ppm or preferably, ±0.05 ppm. For this purpose the reference signal source 14 may comprise compensated crystal oscillators from the group of temperature compensated crystal oscillators (TCXO), microcomputer compensated crystal oscillators (MCXO) and/or Oven-Controlled Crystal Oscillator (OCXO). Because of the power required to run a heater, OCXOs require more power than oscillators that run at ambient temperature, and the requirement for the heater, thermal mass, and thermal insulation means that they are physically larger. Therefore OCXOs are typically not used in battery powered or miniature mobile terminals, such as mobile phones. Since in embodiments the apparatus 10 and, hence, the reference signal source 14 is implemented in an aircraft, there is no limitation with respect to battery power or size. The OCXO achieves the best frequency stability possible from a crystal. The short term frequency stability of OCXOs is typically 1×10⁻¹² over a few seconds, while the long term stability is limited to around 1×10⁻⁸ (10 ppb) per year by aging the crystal. Achieving better performance requires switching to an atomic frequency standard, such as a rubidium standard, caesium standard, or hydrogen maser. Another cheaper alternative is to discipline a crystal oscillator with a GPS time signal, creating a so-called GPS Disciplined oscillator (GPSDO). Using an onboard GPS receiver of the aircraft that can generate accurate time signals (down to within ˜30 ns of UTC), a GPSDO can maintain oscillation accuracy of 10⁻¹³ for extended periods of time.

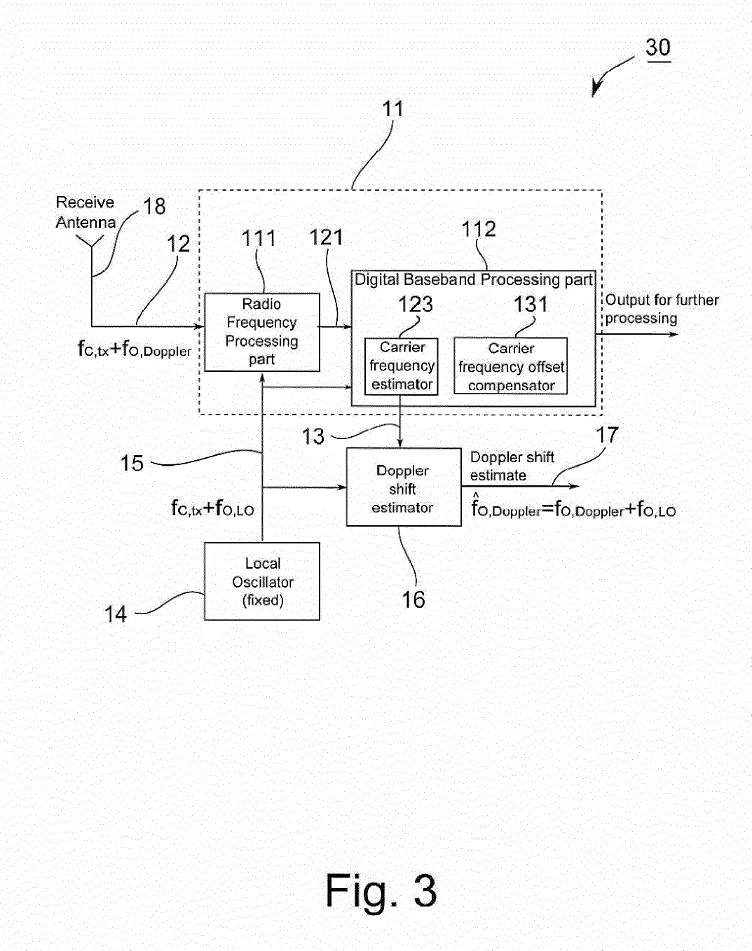

Turning now to FIG. 3 a further embodiment of an apparatus for determining an estimate 17 of a frequency offset fₒ between a carrier or center frequency f_{C,rx} of the received signal 12 and a carrier or center frequency f_{C,tx} of a transmitted signal will be explained. Again, the same reference numerals as in FIG. 1 and/or FIG. 2 indicate similar functional components and/or signals.

As well as the apparatus 10 and the apparatus 20, the apparatus 30 may be incorporated in an aircraft onboard terminal for a DA2G communication with a base station of a terrestrial mobile communications network. The apparatus 30 differs from the apparatus 20 in that the down-conversion of the received (uplink) signal 12 to the baseband domain is done by mixing the received signal 12 a fixed-frequency reference signal 15 instead of mixing the received signal 12 with a variable output of a tunable local oscillator. In the embodiment of FIG. 3 the independent reference signal source 14 comprises a local oscillator with a fixed reference frequency f_{ref}. The fixed reference frequency f_{ref} may correspond to the transmitted carrier or center frequency f_{C,tx}—at least within a predefined tolerance range, i.e., f_{ref}=f_{C,tx}+Δf_{ref}. Slight variations Δf_{ref} from the nominal transmit carrier frequency f_{C,tx} within a range of ±0.05 ppm are hardly avoidable—even with high-precision reference signal sources 14, like the above-mentioned TCXOs, MCXOs, OCXOs, and GPSDOs. Again the reference signal source 14 may be adapted to generate the reference signal 15 independently from other signal or clock sources used to process the received signal 12.

The output signal 15 of the reference signal source 14, i.e. the fixed local oscillator, has the reference frequency f_{ref}=F_{C,tx}+Δf_{ref}, wherein Δf_{ref} denote oscillator frequency variations with the predefined tolerance range. The output signal 15 of the reference signal source 14 is fed to the RF-processing block 111 in order to down-convert the received signal 12 having the received signal frequency f_{C,rx}=f_{C,tx}+f_{o,Doppler}. The resulting down-converted baseband signal 121 having the baseband frequency offset fₒ=f_{C,rx}−f_{ref}=f_{o,Doppler}−Δf_{ref} is then fed to the digital baseband processor 112 for carrier or Doppler frequency estimation. The digital baseband processor 112 is adapted to estimate the received carrier frequency f_{C,rx} by means of a carrier frequency estimator 123 which may be implemented by digital baseband processing algorithms. A coarse estimate 13 for the carrier frequency f_{C,rx} may e.g. be obtained by the above-explained cell search procedures using primary and/or secondary synchronization signals comprised by the received signal 12 and, hence, the down-converted baseband signal 121. Also the frequency f_{ref} of the reference signal source 14 may be chosen based on an outcome of said cell search procedure. As has already be explained above, frequency information of the reference signal 15 may be used in the baseband part 112, 123 in order to avoid or clear out ambiguities when estimating the carrier frequency or the Doppler frequency offset, the frequency information of the reference signal 15 indicating its reference frequency f_{ref}=f_{C,tx}+Δf_{ref}.

The estimate 13 of the received signal carrier frequency f_{C,rx} serves as a first input to the estimator 16, which may be implemented in the baseband domain. The reference signal 15 having the reference frequency f_{ref}=f_{C,tx}+Δf_{ref} or frequency information thereof serves a second input to the frequency-offset-estimator 16. Based on the first and the second input 13, 15 the frequency-offset-estimator 16 may perform an estimation of the frequency offset fₒ, which is a combination of the Doppler frequency shift f_{o,Doppler} and the local oscillator frequency variation Δf_{ref}.

In the embodiment of FIG. 3 the carrier frequency offset from the Doppler shift f_{o,Doppler} plus any offset Δf_{ref} coming from an inaccuracy of the reference signal source 14 is not compensated by tuning a local oscillator that is used as a reference for the analog radio frequency and digital baseband processing parts 111 and 112. However, the frequency offset fₒ may be fully compensated by a carrier frequency offset compensator 131 in the digital domain by appropriate algorithms. Hence, for the carrier frequency offset compensation embodiments of apparatus 30 the mobile terminal further comprise a frequency offset compensator 131 being adapted to configure a carrier frequency of a reverse link (uplink) radio signal based on the estimated frequency offset 17 and a transmitter for transmitting the reverse link radio signal via a reverse communication link (up-link) to an origin of the transmitted signal, i.e. a ground-located base station. The output 13 from the carrier frequency estimator 123 may be directly compared to the frequency F_{ref}=f_{C,tx}+Δf_{ref} of the reference local oscillator 14 to obtain the estimate 17 of the Doppler shift f_{o,Doppler}. In this implementation the reference local oscillator 14 should possibly be accurate enough such that there negligible frequency offset f_{ref} in addition to the frequency offset caused by the Doppler shift. Otherwise the frequency compensation for the uplink transmission by −2f_{o,Doppler} in case of TDD and by—(f_{o,Doppler}+f_{o,Doppler,UL}) in case of FDD leads to a remaining offset of ±Δf_{ref} at the base station uplink receiver. Thereby the uplink Doppler shift estimate f_{o,Doppler,UL} may be derived from the downlink Doppler shift estimate f_{o,Doppler} by accounting for a duplex frequency offset Δf_{FDD} between the defined downlink and uplink carrier frequencies f_{C,tx,DL}, f_{C,tx,UL}, i.e. f_{o,Doppler,UL}=f_{o,Doppler}·f_{C,tx,UL}/f_{C,tx,DL}.

Note that in embodiments the frequency accuracy that needs to be achieved by the highly accurate reference signal source 14 and/or the local oscillator 113 comprised by the aircraft's onboard terminal receiver should be such that unwanted frequency offsets Δf_{ref} due to oscillator inaccuracies are tolerable with in defined performance bounds in the processing chains of the terminals downlink receiver, its uplink transmitter as well as the base station's uplink receiver. Furthermore, the accuracy of a local oscillator at the ground-located base station used to generate the downlink signal is assumed to be a high enough such that any frequency offsets coming therefrom are negligible.

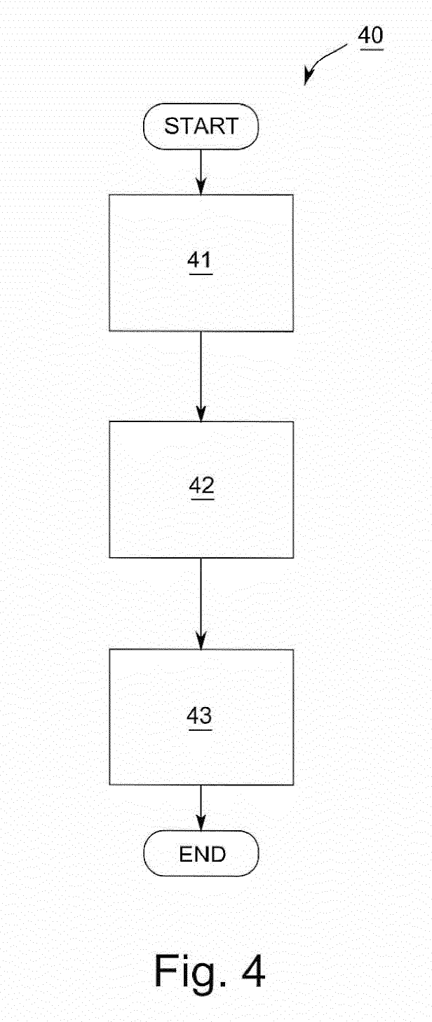

Embodiments may also comprise a method for determining an estimate of a frequency offset between a carrier frequency of a received signal and a carrier frequency of a transmitted signal. An embodiment of such a method 40 is depicted in the schematic block-diagram of FIG. 4.

The method 40 for determining the frequency-offset-estimate comprises, in a first step 41, determining, based on the received signal 12, an estimate of the carrier frequency f_{C,rx} of the received signal 12. As has been explained before in the embodiments according to FIG. 2 and FIG. 3, this may be done with the processor 11 which may have RF- and baseband processing parts 111, 112 and 113. Further, the method 40 comprises a step 42 of generating a reference signal 15 having a reference frequency f_{ref} corresponding, within a predefined tolerance range Δf_{ref}, to the carrier frequency f_{C,tx} of the transmitted signal. Thereby, the reference signal 15 is generated with a highly accurate reference signal source 14 comprising, e.g., highly stable oscillators with a frequency stability which is comparable to high-accuracy reference signal sources commonly used in base stations. In a further step 43 the frequency offset fₒ is estimated based on the estimated carrier frequency f_{C,rx} of the received signal 12 and the reference frequency f_{ref} of the generated reference signal 15. Possible physical realizations of said estimation step have been explained with reference to FIGS. 2 and 3.

A person of skill in the art would readily recognize steps of various above-described methods can be also performed by programmed computers or signal processors. Herein, some embodiments are also intended to cover program storage devices, e.g., digital data storage media, which are machine or computer readable and encode machine-executable or computer-executable programs of instructions, wherein said instructions perform some or all the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

The description and drawings merely illustrate the principles of the invention. It will thus be appreciated that those skilled in the art be able to devise various arrangements that, although not explicitly described or shown herein, embody the principles of the invention and are included within its spirit and scope. Furthermore all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

The functions of the various elements shown in the figures, including any functional blocks labeled as “processor”, “signal source” or “estimator”, may be provided through the use of dedicated hardware, as e.g. a processor, as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM) and non-volatile storage. Other hardware, conventional and/or custom, may also be included.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

1. A mobile terminal apparatus for determining an estimate of a frequency offset between a carrier frequency of a received signal and a carrier frequency of a transmitted signal, the apparatus comprising:
a processor for determining, based on the received signal, an estimate of the carrier frequency of the received signal;
a highly accurate reference signal source for generating a reference signal having a fixed reference frequency corresponding, with a frequency stability which is comparable to high-accuracy reference signal sources used in base stations, to the carrier frequency of the transmitted signal; and
an estimator for estimating the frequency offset based on the estimated carrier frequency of the received signal and the fixed reference frequency of the reference signal.

2. The mobile terminal apparatus according to claim 1, wherein the processor is adapted to determine the estimate of the carrier frequency of the received signal based on a center frequency of a received signal frequency spectrum.

3. The mobile terminal apparatus according to claim 1, wherein the processor is adapted to synchronize, based on the received signal, a frequency of a tunable local oscillator to the carrier frequency of the received signal to obtain a synchronized frequency of the tunable local oscillator as the estimate of the carrier frequency.

4. The mobile terminal apparatus according to claim 3, wherein the estimator is adapted to estimate the frequency offset based on a difference between the synchronized frequency of the tunable local oscillator and the fixed reference frequency of the reference signal.

5. The mobile terminal apparatus according to claim 4, wherein the estimator comprises a frequency comparator to determine the difference between the synchronized frequency and the reference frequency.

6. The mobile terminal apparatus according to claim 1, wherein the processor is adapted to determine the estimate of the carrier frequency of the received signal based on the reference signal and a down-converted signal, which is obtained based on mixing the reference signal with the received signal.

7. The apparatus according to claim 1, wherein the highly accurate reference signal source is adapted to generate the reference signal such that its reference frequency corresponds to the carrier frequency of the transmitted signal within a range of ±0.1 ppm, in particular within a range of ±0.05 ppm.

8. The mobile terminal apparatus according to claim 1, wherein the highly accurate reference signal source is adapted to generate the reference signal independently from other signal sources used to process the received signal.

9. The mobile terminal apparatus according to claim 1, further comprising:
a transmitter for transmitting a radio signal via a reverse communication link to an origin of the transmitted signal; and
a frequency offset compensator being adapted to configure a carrier frequency of the radio signal based on the estimated frequency offset.

10. The mobile terminal apparatus according to claim 1, being adapted to determine, as the frequency offset, an estimate of a Doppler frequency offset for a direct air-to-ground communication using a terrestrial mobile communications network between a mobile terminal located in an aircraft and a ground-located base station.

11. The mobile terminal apparatus according to claim 1, wherein the received signal is a version of the transmitted signal compromised by a wireless communications channel between a receiver of the received signal and a transmitter of the transmitted signal.

12. The apparatus according to claim 1, wherein the transmitted signal is a code division multiplexing signal or an orthogonal frequency division multiplexing signal.

13. An aircraft comprising the mobile terminal apparatus according to claim 1 for a direct air-to-ground communication using a terrestrial mobile communications network.

14. A method for determining an estimate of a frequency offset between a carrier frequency of a signal received at a mobile terminal and a carrier frequency of a transmitted signal, the method comprising:
determining, based on the received signal, an estimate of the carrier frequency of the received signal;
generating a highly accurate reference signal having a fixed reference frequency corresponding, with a frequency stability which is comparable to high-accuracy reference signal sources used in base stations, to the carrier frequency of the transmitted signal; and
estimating the frequency offset based on the estimated carrier frequency of the received signal and the fixed reference frequency of the reference signal.

15. A computer program having a program code for performing the method of claim 14 when the computer program is executed on a computer or processor.
